(19) United States
(12) Patent Application Publication
(10) Pub. No.: US 2003/0014248 A1
(43) Pub. Date: Jan. 16, 2003

(54) Method and system for enhancing speech in a noisy environment

(75) Inventor: Rolf Vetter, Yverdon (CH)

Correspondence Address: SUGHRUE MION, PLLC, 2100 PENNSYLVANIA AVENUE, N.W., WASHINGTON, DC, 20037, US

(73) Assignee: CSEM, CENTRE SUISSE D'ELECTRONIQUE ET DE MICROTECHNIQUE SA

(21) Appl. No.: 10/124,332

(22) Filed: Apr. 18, 2002

(30) Foreign Application Priority Data
Apr. 27, 2001 (EP) 01201551.7

(51) Int. Cl. G10L 21/02

(52) U.S. Cl. 704/226

(57) ABSTRACT

There is described a method and system for enhancing speech in a noisy environment. The method operates on a frame-to-frame basis and preferably uses a Discrete Cosine Transform (DCT) to transform time-domain components of an input signal into frequency-domain components. The speech enhancement method is essentially based on a subspace approach in the so-called Bark-domain and an optimal subspace selection using a Minimum Description Length (MDL) criterion.

The MDL-based subspace selection leads to a partition of the multi-dimensional space of noisy data into a noise subspace, a signal subspace and a signal-plus-noise subspace. The enhanced signal is reconstructed by applying the inverse transform to the components of the signal subspace and weighted components of the signal-plus-noise subspace, the noise subspace being nulled during this reconstruction.

The resulting enhancement method provides maximum noise reduction while minimizing signal distortions such as the so-called musical residual noise encountered with conventional subtractive-type enhancement methods.

### FIELD OF INVENTION

This invention is in the field of signal processing and is more specifically directed to noise suppression (or, conversely, signal enhancement) in the telecommunication of human speech.

### BACKGROUND OF THE INVENTION

Speech enhancement is often necessary to reduce listener's fatigue or to improve the performance of automatic speech processing systems. A major class of noise suppression techniques is referred to in the art as spectral subtraction. Spectral subtraction, in general, considers the transmitted noisy signal as the sum of the desired speech signal with a noise component.

A typical approach consists in estimating the spectrum of the noise component and then subtracting this estimated noise spectrum, in the frequency domain, from the transmitted noisy signal to yield the remaining desired speech signal.

Subtractive type techniques are typically based on the Discrete Fourier Transform (DFT) and constitute a traditional approach for removing stationary background noise in single channel systems. A major problem however with most of these methods is that they suffer from a distortion called “musical residual noise”.

To reduce this distortion, a prior art method has been proposed which utilizes the simultaneous masking effect of the human ear. It has been observed that the human ear ignores, or at least tolerates, additive noise so long as its amplitude remains below a masking threshold in each of multiple critical frequency bands within the human ear. As is well known in the art, a critical band is a band of frequencies that are equally perceived by the human ear. N. Virag, “Single Channel Speech Enhancement Based on Masking Properties of the Human Auditory System”, IEEE Transactions on Speech and Audio Processing, Vol. 7, No. 2 (March 1999), pp. 126-137, describes a technique in which masking thresholds are defined for each critical band, and are used in optimizing spectral subtraction to account for the extent to which noise is masked during speech intervals.

Improvements have also been achieved by using eigenspace approaches based on Karhunen-Loève Transform (KLT). Y. Ephraim et al., “A Signal Subspace Approach for Speech Enhancement”, IEEE Transactions on Speech and Audio Processing, Vol. 3, No. 4 (July 1995), pp. 251-266, describes a subspace approach based on KLT. The underlying principle of this subspace approach is to observe the data in a large dimensional space of delayed coordinates. Since noise is assumed to be random, it extends approximately in uniform manner in all the directions of this space, while in contrast, the dynamics of the deterministic system underlying the speech signal confine the trajectories of the useful signal to a lower-dimensional subspace. Consequently, the eigenspace of the noisy signal is partitioned into a noise subspace and signal-plus-noise subspace. Enhancement is obtained by removing the noise subspace and optimally weighting the signal-plus-noise subspace.

Notably, it has been shown that highest performance is obtained when using KLT with an associated subspace selection using the Minimum Description Length (MDL) criterion. Vetter et al., “Single Channel Speech Enhancement Using Principal Component Analysis and MDL Subspace Selection”, in Proceedings of the 6^{th} European Conference on Speech Communication and Technology (Eurospeech '99), Budapest, Hungary (Sep. 5-9, 1999), vol. 5, pp. 2411-2414, which is incorporated herein by reference, describes a subspace approach for single channel speech enhancement and speech recognition in highly noisy environments which is based on Principal Component Analysis (PCA). According to this particular approach, in order to maximize noise reduction and minimize signal distortion, the eigenspace of the noisy data is partitioned into three different subspaces:

i) a noise subspace which contains mainly noise contributions. These components are nulled during reconstruction;

ii) a signal subspace containing components with high signal-to-noise ratios (SNRⱼ>>1). Components of this subspace are not weighted since they contain mainly components from the original signal. This allows a minimization of the signal distortion; and

iii) a signal-plus-noise subspace which includes the components with SNRⱼ≈1. The estimation of the dimension of this subspace can only be done with a high error probability. Consequently, principal components with SNRⱼ<1 may belong to it and a weighting is applied during reconstruction.

The general enhancement scheme of this prior art approach is represented in FIG. 1. A detailed description of this enhancement scheme is described in the above-mentioned Vetter et al. reference.

The above-cited KLT-based subspace approaches are however not appropriate for real time implementation since the eigenvectors or eigenfilters have to be computed during each frame, which implies high computational requirements.

It is thus a principal object of the present invention to provide a method and a system for enhancing speech in a noisy environment which yields the robustness and efficiency of the KLT-based subspace approaches.

It is a further object of the present invention to provide a method and a system for enhancing speech which implies low computational requirements and thus allows this method to be implemented and this system to be used for real time speech enhancement in real world conditions.

### SUMMARY OF THE INVENTION

Accordingly, there is provided a method for enhancing speech in a noisy environment the features of which are cited in claim 1.

There is also provided a system for enhancing speech in a noisy environment the features of which are cited in claim 18.

Other advantageous embodiments of the invention are the object of the dependent claims.

According to the present invention, in order to circumvent the above-mentioned drawback of the KLT-based subspace approaches, i.e. the high computational requirements, one uses prior knowledge about perceptual properties of the human auditory system. In particular, according to the present invention, one substitutes the eigenfilters in the KLT approach by the so-called Bark filters.

According to a preferred embodiment of the present invention, this Bark filtering is processed in the DCT domain, i.e. a Discrete Cosine Transform is performed. It has been shown that DCT provides significantly higher energy compaction as compared to the DFT which is conventionally used. In fact, its performance is very close to the optimum KLT. It will however be appreciated that DFT is equally applicable despite yielding lower performance.

The method according to the present invention provides similar performance in terms of robustness and efficiency with respect to the KLT-based subspace approaches of Ephraim et al. and Vetter et al. In contrast to these prior art enhancing methods, the computational load of the method according to the present invention is however reduced by an order of magnitude and thus promotes this method as a promising solution for real time speech enhancement.

### BRIEF DESCRIPTION OF THE DRAWINGS

Other aspects, features and advantages of the present invention will be apparent upon reading the following detailed description of non-limiting examples and embodiments made with reference to the accompanying drawings, in which:

FIG. 1 schematically illustrates a prior art speech enhancing scheme based on Karhunen-Loève Transform KLT, or Principal Component Analysis, with an associated Minimum Description Length (MDL) criterion;

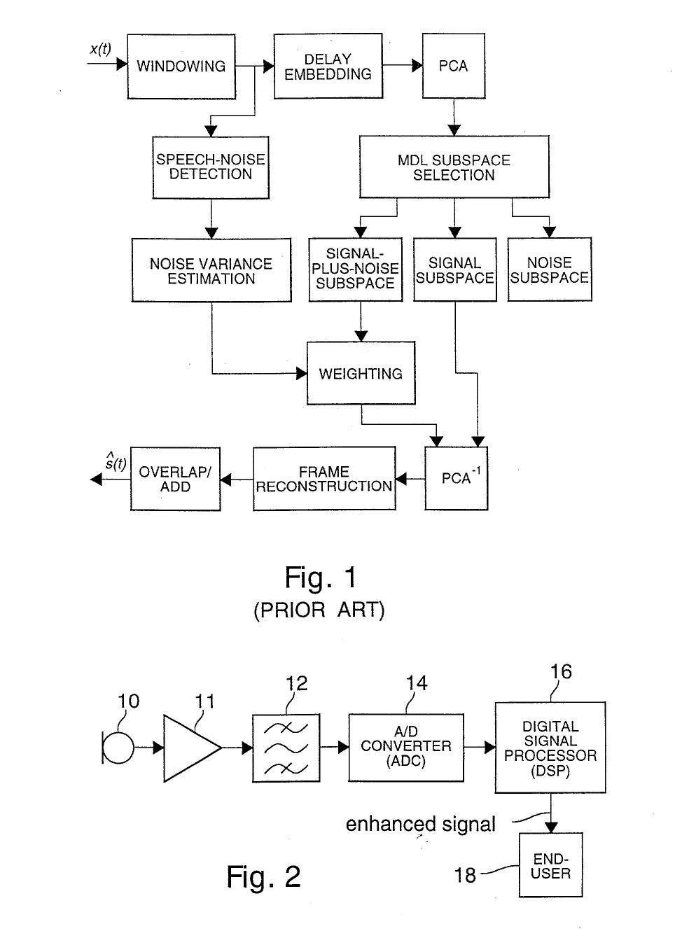

FIG. 2 is a block diagram of a single channel speech enhancement system for implementing a first embodiment of the method according to the present invention;

FIG. 3 is a flow chart generally illustrating the speech enhancement method of the present invention;

FIG. 4 schematically illustrates a preferred embodiment of a single channel speech enhancing scheme according to the present invention based on a Discrete Cosine Transform (DCT);

FIG. 5 illustrate a typical genetic algorithm (GA) cycle which may be used for optimizing the parameters of the speech enhancement method of the present invention;

FIGS. 6a to 6d are speech spectrograms illustrating the efficiency of the speech enhancing method of the present invention, in particular as compared to classical subtractive-type enhancing scheme using DFT such as non-linear spectral subtraction (NSS);

FIG. 6e illustrate the signal and signal-plus-noise subspace dimensions (p₁ and p₂) estimated using the method of the present invention;

FIG. 7 is a block diagram of a dual channel speech enhancement system for implementing a second embodiment of the method according to the present invention; and

FIG. 8 schematically illustrates a preferred embodiment of a dual channel speech enhancing scheme according to the present invention based on DCT.

### DETAILED DESCRIPTION OF THE PREFERRED EMBODIMENTS

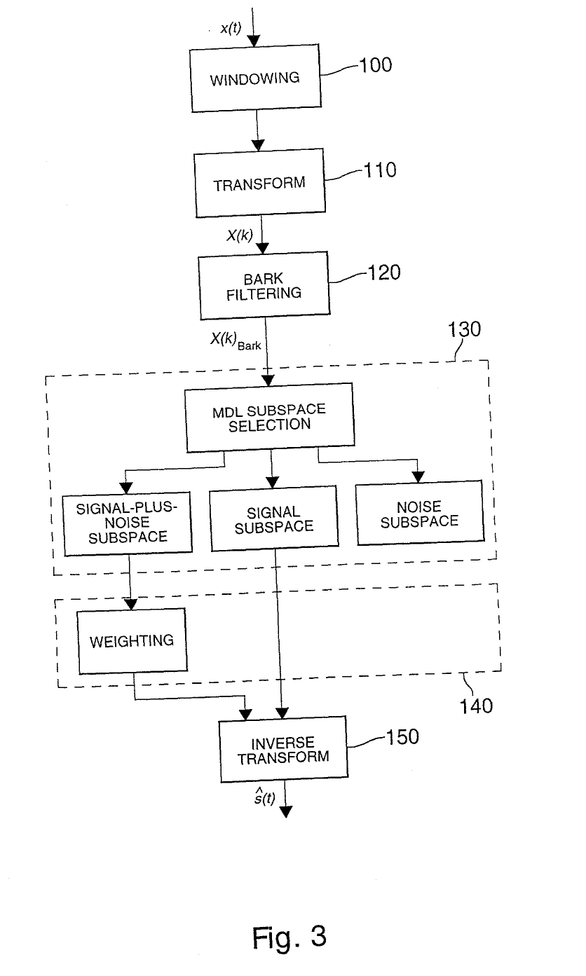

FIG. 2 schematically shows a single channel speech enhancement system for implementing the speech enhancement scheme according to the present invention. This system basically comprises a microphone 10 with associated amplifying means 11 for detecting the input noisy signals, a filter 12 connected to the microphone 10, and an analog-to-digital converter (ADC) 14 for sampling and converting the received signal into digital form. The output of the ADC 14 is applied to a digital signal processor (DSP) 16 programmed to process the signals according to the invention which will be described hereinbelow. The enhanced signals produced at the output of the DSP 16 are supplied to an end-user system 18 such as an automatic speech processing system.

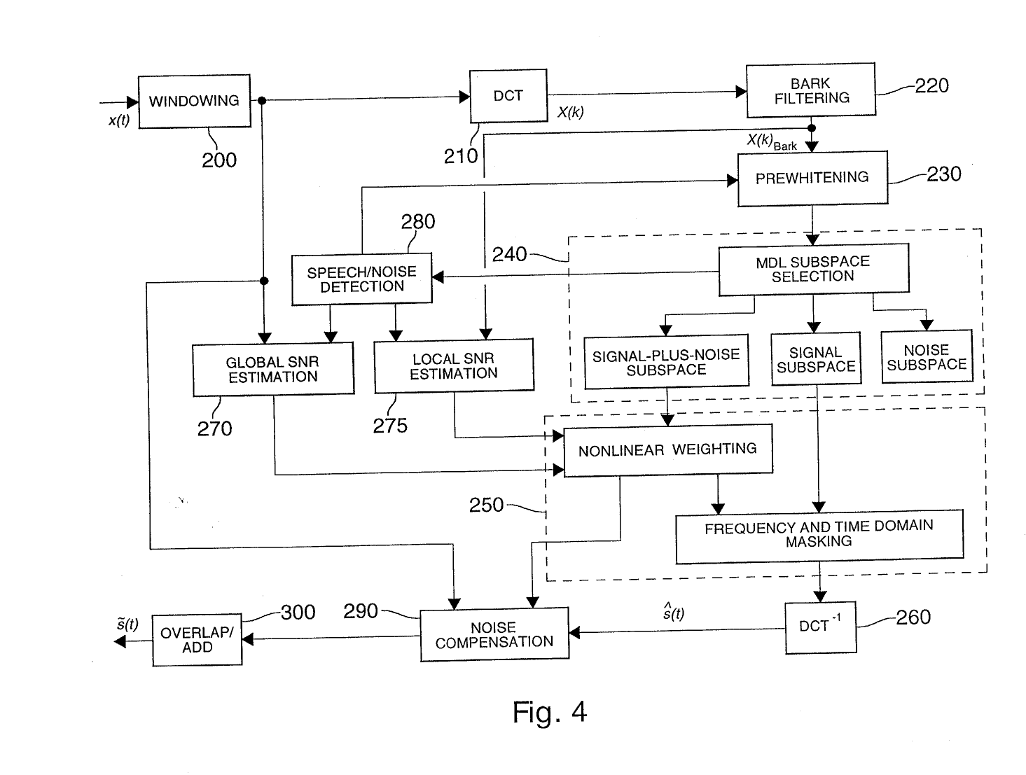

The DSP 16 is programmed to perform noise suppression upon received speech and audio input from microphone 10. FIG. 3 schematically shows the sequence of operations performed by DSP 16 in suppressing noise and enhancing speech in the input signal according to a preferred embodiment of the invention which will now be described.

As illustrated in FIG. 3, the input signal is firstly subdivided into a plurality of frames each comprising N samples by typically applying Hanning windowing with a certain overlap percentage. It will thus be appreciated that the method according to the present invention operates on a frame-to-frame basis. After this windowing process, indicated 100 in FIG. 3, a transform is applied to these N samples, as indicated by step 110, to produce N frequency-domain components indicated X(k).

These frequency-domain components X(k) are then filtered at step 120 by so-called Bark filters to produce N Bark components, indicated X(k)_{Bark}, for each frame and are then subjected to a subspace selection process 130, which will be described hereinbelow in greater details, to partition the noisy data into three different subspaces, namely a noise subspace, a signal subspace and a signal-plus-noise subspace.

The enhanced signal is obtained by applying the inverse transform (step 150) to components of the signal subspace and weighted components of the signal-plus-noise subspace, the noise subspace being nulled during reconstruction (step 140).

The global framework for the subspace approach according to the present invention is described hereinbelow in greater details. In the context of the present invention, one considers the problem of additive noise, which implies that the observed noisy signal x(t) is given by:

x(t)=s(t)+n(t) t=0, . . . ,Nₜ−1 (1)

where s(t) is the speech signal of interest, n(t) is a zero mean, additive stationary background noise, and Nₜ is the number of observed samples.

In a general way, as already mentioned, the basic idea in subspace approaches can be formulated as follows: the noisy data is observed in a large m-dimensional space of a given dual domain (for example the eigenspace computed by KLT as described in Y. Ephraim et al., “A Signal Subspace Approach for Speech Enhancement”, cited hereinabove). If the noise is random and white, it extends approximately in a uniform manner in all directions of this dual domain, while, in contrast, the dynamics of the deterministic system underlying the speech signal confine the trajectories of the useful signal to a lower-dimensional subspace of dimension p<m. As a consequence, the eigenspace of the noisy signal is partitioned into a noise subspace and a signal-plus-noise subspace. Enhancement is obtained by nulling the noise subspace and optimally weighting the signal-plus-noise subspace.

The optimal design of such a subspace algorithm is a difficult task. The subspace dimension p should be chosen during each frame in an optimal manner through an appropriate selection rule. Furthermore, the weighting of the signal-plus-noise subspace introduces a considerable amount of speech distortion.

As already mentioned, in order to simultaneously maximize noise reduction and minimize signal distortion, there has already been proposed in Vetter et al., “Single Channel Speech Enhancement Using Principal Component Analysis and MDL Subspace Selection” (already cited hereinabove and incorporated herein by reference) a promising approach consisting in a partition of the eigenspace of the noisy data into three different subspaces, namely:

i) a noise subspace of dimension m−p₂ which contains mainly noise contributions. These components are nulled during reconstruction;

ii) a signal subspace of dimension p₁ containing components with high signal-to-noise ratios (SNRⱼ>>1). Components of this subspace are not weighted since they contain mainly components from the original signal. This allows a minimization of the signal distortion; and

iii) a signal-plus-noise subspace of dimension p₂−p₁ which includes the components with SNRⱼ≈1. The estimation of the dimension of this subspace can only be done with a high error probability. Consequently, principal components with SNRⱼ<1 may belong to it and a weighting is applied during reconstruction.

A similar approach is used according to the present invention (step 130 in FIG. 3) to partition the space of noisy data. In classical subspace approaches, components of the dual domain are obtained by applying the eigenvectors or eigenfilters computed by KLT on the delay embedded noisy data. To avoid the large computational means required for these operations, it is proposed, according to the present invention, to use masking properties of the human auditory system in order to substitute the eigenfilters of the classical subspace approaches by the so-called Bark filters.

Noise masking is a well known feature of the human auditory system. It denotes the fact that the auditory system is incapable to distinguish two signals close in the time or frequency domains. This is manifested by an elevation of the minimum threshold of audibility due to a masker signal, which has motivated its use in the enhancement process to mask the residual noise and/or signal distortion. The most applied property of the human ear is simultaneous masking. It denotes the fact that the perception of a signal at a particular frequency by the auditory system is influenced by the energy of a perturbing signal in a critical band around this frequency. Furthermore, the bandwidth of a critical band varies with frequency, beginning at about 100 Hz for frequencies below 1 kHz, and increasing up to 1 kHz for frequencies above 4 kHz.

From the signal processing point of view the simultaneous masking is implemented by a critical filterbank, the so-called Bark filterbank, which gives equal weight to portions of speech with the same perceptual importance. According to the invention, the prior knowledge about the human auditory system is used to replace the eigenfilters in the KLT approach by Bark filtering.

Furthermore, in order to have a maximum energy compaction the filtering is preferably processed in the Discrete Cosine Transform (DCT) domain. Indeed, DCT outperforms DFT in terms of energy compaction and its performance is very close to the optimum KLT. Again, it will be appreciated that DFT is equally applicable to perform this filtering despite being less optimal than DCT.

Since Bark filtering is based on energy considerations, this filtering is based on the square of the DCT components. Bark components are thus defined by the following expression:

$${X ( k )}_{Bark} = {\sum }_{j = - b / 2}^{b / 2} G ( j , k ) {\{ X ( k - j ) \}}^{2} k = 0 , … , N - 1 \qquad ( 2 )$$

where b+1 is the processing-width of the filter, G(j, k) is the Bark filter whose bandwidth depends on k, and X(k) are the DCT components defined as:

$$X ( k ) = α ( k ) {\sum }_{t = 0}^{N - 1} x ( t ) cos \{ \frac{π ( 2 t + 1 ) k}{2 N} \} \qquad ( 3 )$$

where α(0)=\sqrt{1/N} and α(k)=\sqrt{2/N} for k≠0. At this point it is important to note that by computing dual domain components as given by expression (2), one obtains a dual domain of dimension m=N.

A crucial point in the proposed algorithm is the adequate choice of the dimensions of the signal-plus-noise subspace p₂) and signal subspace (p₁). It requires the use of a truncation criterion applicable for short time series. Among the possible selection criteria, the Minimum Description Length (MDL) criterion has been shown in multiple domains to be a consistent model order estimator, especially for short time series. This high reliability and robustness of the MDL criterion constitutes the primer motivation for its use in the method of the present invention. To achieve this task, it is assumed that the Bark components given by expression (2) above rearranged in decreasing order constitute a liable approximation of the principle components of speech. Under this assumption, the following expression is obtained for the MDL in the case of additive white Gaussian noise as described in Vetter et al. cited hereinabove:

$$MDL ( {p}_{i} ) = - ln \{ \frac{{\prod }_{j = {p}_{i} + 1}^{N} {λ}_{j}^{\frac{1}{N - {p}_{i}}}}{\frac{1}{N - {p}_{i}} {\sum }_{j = {p}_{i} + 1}^{N} {λ}_{j}} \} + M ( \frac{1}{2} + ln [ γ ] ) - \frac{M}{{P}_{i}} {\sum }_{j = 1}^{{P}_{i}} ln [ {λ}_{j} \sqrt{2 / N} ] \qquad ( 4 )$$

where i=1,2,M=pᵢN−pᵢ²/2+pᵢ/2+1 is the number of free parameters and λⱼ for j=0, . . . , N−1 are the Bark components given by expression (2) rearranged in decreasing order. The parameter γ determines the selectivity of MDL. Accordingly, the dimensions p₁ and p₂ are given by the minimum of MDL(pᵢ) with γ=64 and γ=1 respectively. This choice of γ involves that the parameter p₁ provides a very parsimonious representation of the signal whereas p₂ selects also components with signal-to-noise ratios SNRⱼ≈1.

An important feature of the method according to the present invention resides in the fact that frames without any speech activity lead to a null signal subspace. This feature thus yields a very reliable speech/noise detector. This information is used in the present invention to update the Bark spectrum and the variance of noise during frames without any speech activity, which ensures eventually an optimal signal prewhitening and weighting. Notably, it has to be pointed out that the prewhitening of the signal is important since MDL assumes white Gaussian noise.

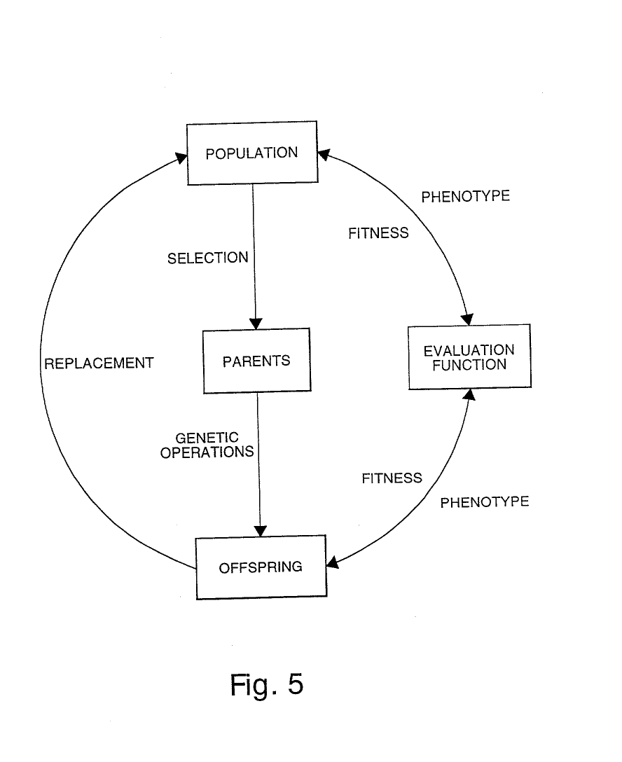

FIG. 4 schematically illustrates the proposed enhancement method according to a preferred embodiment of the present invention. As illustrated, following a windowing process 200, the time-domain components of the noisy signal x(t) are transformed in the frequency-domain (step 210) using DCT to produce frequency-domain components indicated X(k). These components are processed using Bark filters (step 220) as described hereinabove to produce Bark components as defined in expression (2). These Bark components are subjected to a prewhitening process 230 to produce components complying with the assumption made for the subsequent subspace selection process 240 using MDL, namely the fact that MDL assumes white Gaussian noise. The prewhitening process 230 may typically be realized using a so-called whitening filter as described in “Statistical Digital Signal Processing and Modeling”, Monson H. Hayes, Georgia Institute of Technology, John Wiley & Sons (1996), § 3.5, pp. 104-106.

As already described, the MDL-based subspace selection process 240 leads to a partition of the noisy data into a noise subspace of dimension N−p₂, a signal subspace of dimension p and a signal-plus-noise subspace of dimension p₂−p₁. This process also provides indication of frames without any speech activity since the signal subspace is null in that case, i.e. p₁=p₂=0. Speech/noise detection is thus provided at step 280.

The enhanced signal is obtained by applying the inverse DCT to components of the signal subspace and weighted components of the signal-plus-noise subspace (steps 250 and 260 in FIG. 4) followed by overlap/add processing (step 300) since Hanning windowing was initially performed at step 200. Using the definition of inverse DCT it can be written as:

$$\begin{matrix}\hat{s} ( t ) = {\sum }_{j = 1}^{p1} {a}_{{I}_{j}} ( t ) {X}_{{I}_{j}} + {\sum }_{j = p1 + 1}^{p2} {g}_{j} {a}_{{I}_{j}} ( t ) {X}_{{I}_{j}} \\ with & ( 5 ) \\ {a}_{k} ( t ) = a ( k ) cos \{ \frac{π ( 2 t + 1 ) k}{2 N} \} & ( 6 )\end{matrix}$$

where λⱼ for j=1, . . . , N are the Bark components given by expression (2) rearranged in decreasing order, Iⱼ is the index of rearrangement and gⱼ is an appropriate weighting function.

This weighting function gⱼ may for instance result of a time autoregressive moving average domain masking of the form

$${g}_{j} ( k ) = {κ}_{a} {g}_{j} ( k - 1 ) {\sum }_{i = 0}^{κlagb} {κ}_{bi} {\tilde{g}}_{j} ( k - i ) \qquad ( 7 )$$

where the non-filtered weighting function has been chosen as follows:

\tilde{g}ⱼ=exp{−vⱼ/SNRⱼ} j=p₁+1, . . . ,p₂ (8)

where SNRⱼ for j=0, . . . , N−1 is the estimated local signal-to-noise ratio of each Bark component and the parameter v is adjusted through a non-linear probabilistic operator in function of the global signal-to-noise ratio SNR as follows:

$${v}_{j} = \{ \begin{matrix}{f}_{1} \text{(} S \tilde{N} R \text{)} & if j \leq p1 \\ {f}_{2} \text{(} S \tilde{N} R \text{)} & if j \leq p2 \\ {f}_{3} \text{(} S \tilde{N} R \text{)} & if p2 < j \leq N\end{matrix} \qquad ( 9 )$$

where

ƒᵢ=κᵢ₁+κᵢ₂ logsig {κᵢ₃+κᵢ₄SÑR} (10)

and

SÑRmedian(SNR(k), . . . ,SNR(k−lag_{K})) (11)

and SNR(k) is the estimated global logarithmic signal-to-noise ratio.

Referring again to FIG. 4, it will be seen that the global and local signal-to-noise ratios are estimated at steps 270 and 275 respectively for adjusting the above-defined weighting function. Furthermore, these estimations are updated during frames with no speech activity (step 280).

In order to obtain highest perceptual performance one may additionally tolerate background noise of a given level and use a noise compensation (step 290) of the form:

\tilde{s}(t)=v₄ŝ(t)+(1−v₄)x(t) (12)

where

v₄=κ₄(SÑR) (13)

and ƒ₄ is given by expression (10).

The above reconstruction scheme contains a large number of unknown parameters, namely:

κ=[κₐ,κ_{lagb},κ_{b1}, . . . , κ^{blagb},κ₁₁, κ₁₂, . . . , κ₄₄]^{T} (14)

This parameter set should be optimised to obtain highest performance. To this effect so-called genetic algorithms (GA) are preferably applied for the estimation of the optimal parameter set.

Genetic algorithms, or GAs, have recently attracted growing interest from the signal processing community for the resolution of optimization problems in various application. One may for instance reference to H. Holland, “Adaptation in natural and artificial systems”, the University of Michigan Press, MI, USA (1975), K. S. Tang et al., “Genetic algorithms and their applications”, IEEE Signal Processing Magazine, vol. 13, no. 6 (November 1996), pp. 22-37, R. Vetter et al., “Observer of the human cardiac sympathetic nerve activity using blind source separation and genetic algorithm optimization”, in the 19^{th} Annual International Conference of the IEEE Engineering in Medicine and Biological Society (EMBS), Chicago (1997), pp. 293-296 or R. Vetter, “Extraction of efficient and characteristics features of multidimensional time series”, PhD thesis, EPFL, Lausanne (1999).

GAs are search algorithms which are based on the laws of natural selection and evolution of a population. They belong to a class of robust optimization techniques that do not require particular constraint, such as for example continuity, differentiability and uni-modality of the search space. In this sense, one can oppose GAs to traditional, calculus-based optimization techniques which employ gradient-directed optimization. GAs are therefore well suited for ill-defined problems as the problem of parameter optimization of the speech enhancement method according to the present invention.

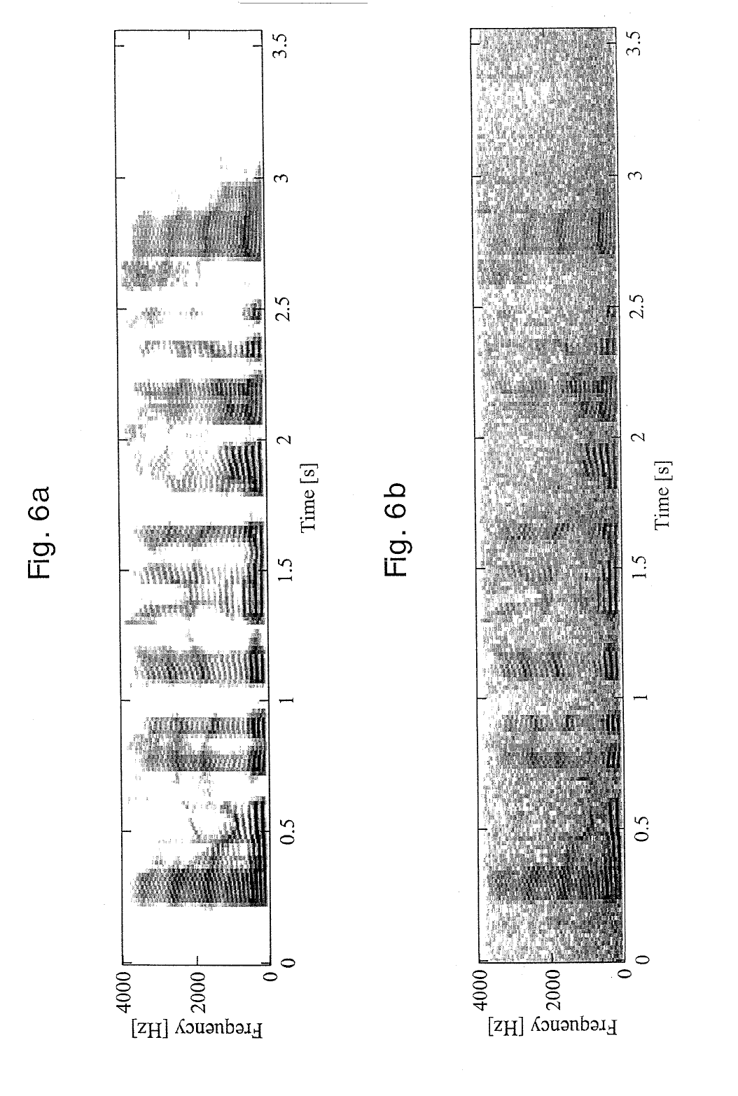

The general structure of a GA is illustrated in FIG. 5. A GA operates on a population which comprises a set of chromosomes. These chromosomes constitute candidates for the solution of a problem. The evolution of the chromosomes from current generations (parents) to new generations (offspring) is guided in a simple GA by three fundamental operations: selection, genetic operations and replacement.

The selection of parents emulates a “survival-of-the-fittest” mechanism in nature. A fitter parent creates through reproduction a larger offspring and the chances of survival of the respective chromosomes are increased. During reproduction chromosomes can be modified through mutation and crossover operations. Mutation introduces random variations into the chromosomes, which provides slightly different features in its offspring. In contrast, crossover combines subparts of two parent chromosomes and produces offspring that contain some parts of both parent's genetic material. Due to the selection process, the performance of the fittest member of the population improves from generation to generation until some optimum is reached. Nevertheless, due to the randomness of the genetic operations, it is generally difficult to evaluate the convergence behaviour of GAs. Particularly, the convergence rate of GA is strongly influenced by the applied parameter encoding scheme as discussed in C. Z. Janikow et al., “An experimental comparison of binary and floating point representation in genetic algorithms”, in Proceedings of the 4^{th} International Conference on Genetic Algorithms (1991), pp. 31-36. In classical GAs, parameters are often encoded by binary numbers. However, it has been shown in C. Z. Janikow et al. that the convergence of GAs can be improved through floating point representation of chromosomes.

In the problem at hand, the aim is at estimating the parameters of the proposed speech enhancement method to obtain highest performance. The population consists therefore of chromosomes cᵢ, i=1, . . . , L, each one containing a set of encoded parameters k of a candidate method. The range of values of these parameters is bounded due to the nature of the problem at hand. This, in fact, imposes a bounded searching space, which is a necessary condition for global convergence of GAs. In the optimization problem at hand order to achieve the evolution of the population is guided by a specific GA particularly adapted for small populations.

This algorithm was first introduced by D. E. Goldberg in “Genetic algorithm in search, optimization, and machine learning”, Addison Wesley Reading, USA (1989) and has been shown to provide high performance in numerous applications. The algorithm can be summarized as follows:

Generate randomly an initial population P(0)=[c₁. . . c_{L}], with L an odd integer;

Compute the fitness F of each chromosomes in the current population;

Create new chromosomes by applying one of the following operations:

Elitist strategy: the chromosome with the best fitness goes unchanged into the next generation;

Mutation: (L-1)/2 mutations from the fittest chromosome are passed to the next generation. (L-1)/4 chromosomes are created by adding Gaussian noise with a variance σ₁ to a randomly selected parameter of the fittest chromosome and the same operation with variance σ₂<<σ₁ is performed for the remaining (L-1)/4 chromosomes;

Crossover: Each chromosome competes with its neighbour. The losers are discarded whereas the winners are put in a mating pool. From this pool, (L-1)/2 chromosomes are created by crossover operations for the next generation;

Iterate the scheme until convergence is achieved.

The central elements in the proposed GA are the elitist survival strategy, Gaussian mutation in a bounded parameter space, generation of two subpopulations and the fitness functions. The elitist strategy ensures the survival of the fittest chromosome. This implies that the parameters with the highest perceptual performance are always propagated unchanged to the next generation. The bounded parameter space is imposed by the problem at hand and together with Gaussian mutation it guarantees that the probability of convergence of the parameters to the optimal solution is equal to one for an infinite number of generations. The convergence properties are improved by the generation of two subpopulations with various random influences σ₁, σ₂. Since σ₂<<σ₁, the population generated by σ₂ ensures a fast local convergence of the GA. In contrast, the population generated by σ₁ covers the whole parameter space and enables the GA to jump out of local minima and converge to the global minimum.

A very important element of the GA is the fitness function F, which constitutes an objective measure of the performance of the candidates. In the context of speech enhancement, this function should assess the perceptual performance of a particular set of parameters. Thus, the speech intelligibility index (SII) as defined by the American National Standard ANSI S3.5-1997 has been applied. Eventually, GA optimization has been performed on a database consisting of French sentences.

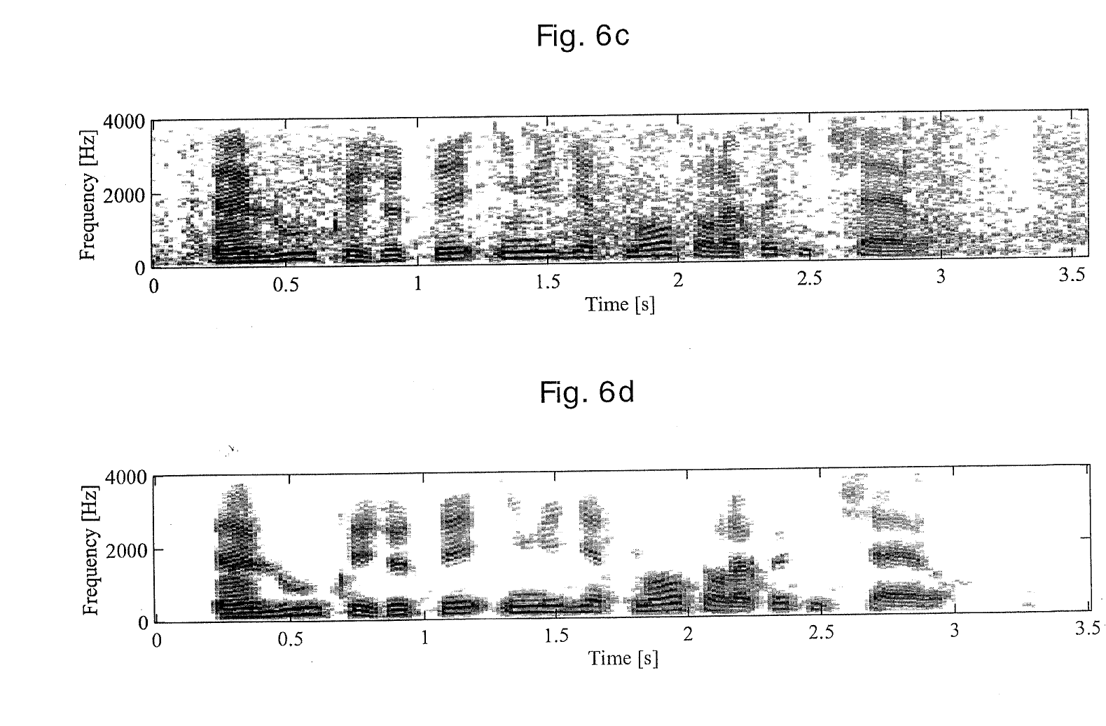

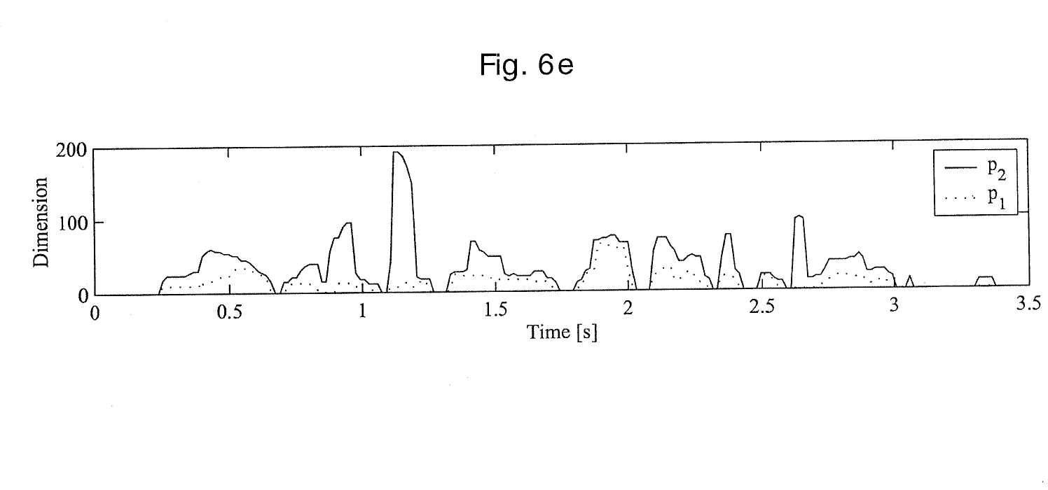

With respect to the performance of the speech enhancing method of the present invention, it has been observed by the authors that subspace approaches generally outperform linear and non-linear subtractive-type methods using DFT. In particular, subspace approaches yield a considerable reduction of the so-called “musical noise”. In a qualitative way, this observation has been confirmed by informal listening tests but also through inspections of the spectrograms shown in FIGS. 6a to 6e.

FIG. 6a schematically shows the speech spectrogram of the original speech signal corresponding to the French sentence “Un loup s'est jeté immédiatement sur la petite chèvre”. FIG. 6b schematically shows the noisy signal (non-stationary factory noise at a segmental input SNR=10 dB). FIG. 6c illustrates the enhanced signal obtained using a non-linear spectral subtraction (NSS) using DFT as described in P. Lockwood “Experiments with a Nonlinear Spectral Subtractor (NSS), Hidden Markov Models and Projection, for Robust Recognition in Cars”, Speech Communications (June 1992), vol. 11, pp. 215-228. FIG. 6d shows the enhanced signal obtained using the enhancing scheme of the present invention and FIG. 6e shows the signal and signal-plus-noise subspace dimensions p₁ and p₂ estimated by MDL.

The analysis of FIG. 6c highlights that NSS provides a considerable amount of residual “musical noise”. In contrast, FIG. 6d underlines the high performance of the proposed approach since it extracts the relevant features of the speech signal and reduces the noise to a tolerable level. This high performance in particular confirms the efficiency and consistency of the MDL-based subspace method.

The method according to the present invention provides similar performance with respect to the subspace approach of Ephraim et al. or Vetter et al. which uses KLT. However, it has to be pointed out that the computational requirements of the method according to the present invention are reduced by an order of magnitude with respect to the known KLT-based subspace approaches.

Furthermore, an important additional feature of the method according to the present invention is that it is highly efficient and robust in detecting speech pauses, even in very noisy conditions. This can be observed in FIG. 6e for the signal subspace dimension is zero during frames without any speech activity.

It will be appreciated that the proposed enhancing method may be applied as part of an enhancing scheme in dual or multiple channel enhancement systems, i.e. systems relying on the presence of multiple microphones. Analysis and combination of the signals received by the multiple microphones enables to further improve the performances of the system notably by allowing one to exploit spatial information in order to improve reverberation cancellation and noise reduction.

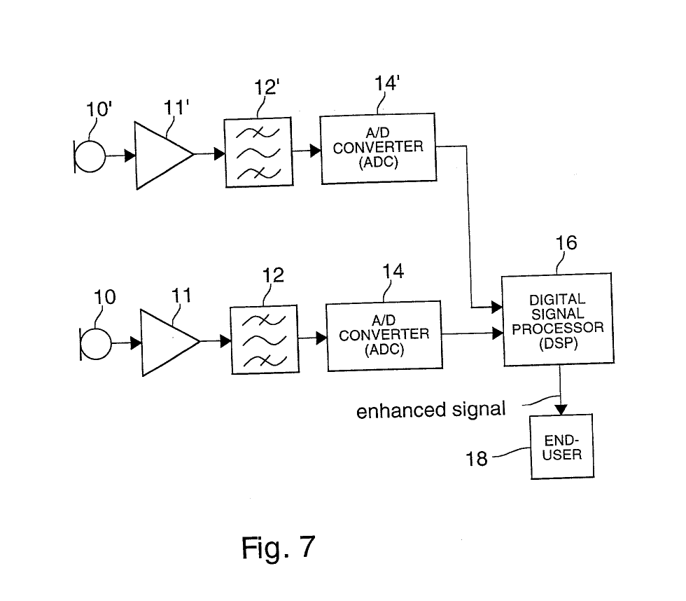

FIG. 7 schematically shows a dual channel speech enhancement system for implementing a speech enhancement scheme according to a second embodiment of the present invention. Similarly to the single channel speech enhancement system of FIG. 2, this dual channel system comprise first and second channels each comprising a microphone 10, 10′ with associated amplifying means 11, 11′, a filter 12, 12′ connected to the microphone 10, 10′ and an analog-to-digital converter (ADC) 14, 14′ for sampling and converting the received signal of each channel into digital form. The digital signals provides by the ADC's 14, 14′ are applied to a digital signal processor (DSP) 16 programmed to process the signals according to the second embodiment which will be described hereinbelow. The enhanced signals produced at the output of the DSP 16 are again supplied to an end-user system 18.

The underlying principle of the dual channel enhancement method is substantially similar to the principle which has been described hereinabove. The dual channel speech enhancement method however makes additional use of a coherence function which allows one to exploit the spatial diversity of the sound field. In essence, this method is a merging of the above-described single channel subspace approach and dual channel speech enhancement based on spatial coherence of noisy sound field. With respect to this latter aspect, one may refer to R. Le Bourquin “Enhancement of noisy speech signals: applications to mobile radio communications”, Speech Communication (1996), vol. 18, pp. 3-19.

Referring to expression (1) above, a speech signal s(t) uttered by a speaker is submitted to modifications due to its propagation. Additionally, some noise is added so that the two resulting signals which are available on the microphones can be written as:

x₁(t)=s₁(t)+n₁(t) x₂(t)=s₂(t)+n₂(t) t=0, . . . ,Nₜ−1 (15)

The present principle is based on the following assumptions: (a1) The microphones are in the direct sound field of the signal of interest, (a2) whereas they are in the diffuse sound field of the noise sources. Assumption (a1) requires that the distance between speaker of interest and microphones is smaller than the critical distance whereas (a2) requires that the distance between noise sources and microphones is larger than the critical distance as specified in M. Drews, “Mikrofonarrays und mehrkanalige Signalverarbeitung zur Verbesserung gestörter Sprache”, PhD thesis, Technische Universität, Berlin (1999). This is a plausible assumption for a large number of applications. As an example, consider a moderately reverberating room with a volume of 125 m³ and a reverberation time of 0.2 seconds which yields a critical distance of r_{c}=1.4 m. Consequently, assumption (a1) is verified if the speaker is nearer than r_{c} while (a2) requires that the noise sources are at a distance larger than r_{c}. The consequence of (a1) is that the contributions of the signal of interest s₁(t) and s₂(t) in the recorded signal are highly correlated. In contrast, (a2) together with a sufficient distance between microphones implies that the contributions of noise n₁(t) and n₂(t) in the recorded signal are weakly correlated. Since signal and noise have generally non-uniform distribution in the time-frequency domain, it is advantageous to perform a correlation measure with respect to frequency and time. This leads to the concept of time adaptive coherence function.

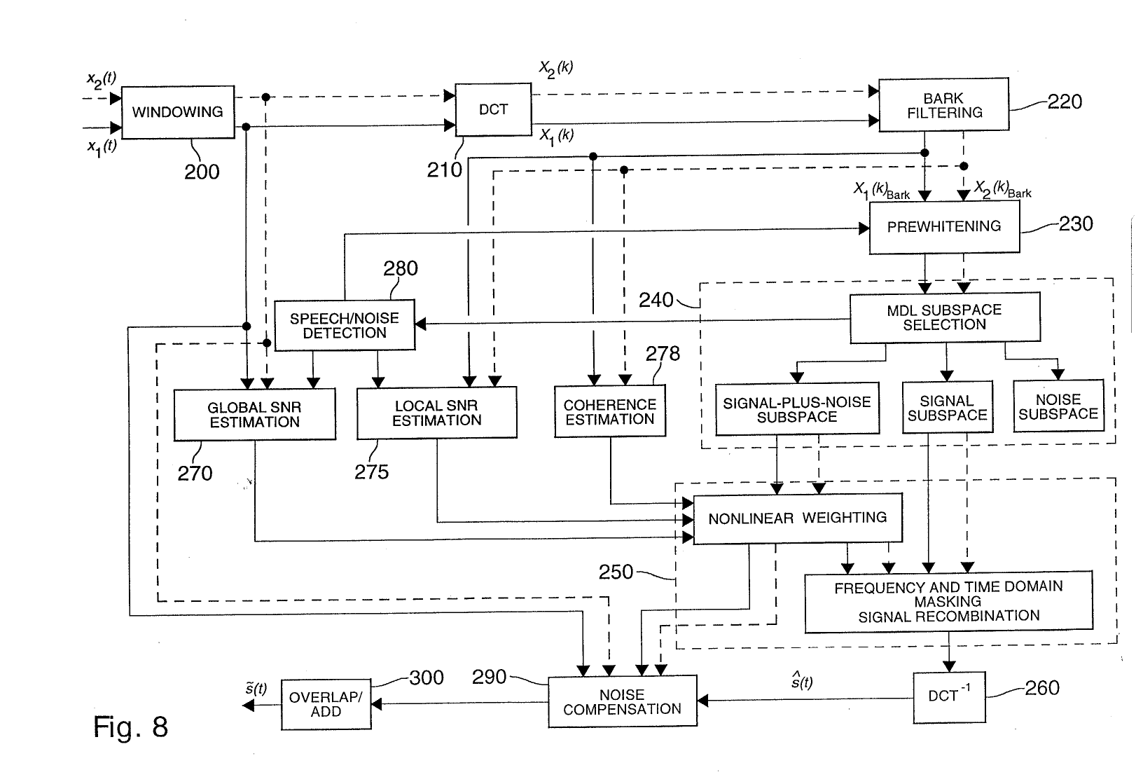

FIG. 8 schematically illustrates the proposed dual channel speech enhancement method according to a preferred embodiment of the invention. The steps which are similar to the steps of FIG. 4 are indicated by the same reference numerals and are not described here again. As illustrated, following the windowing process 200, the time-domain components of the noisy signals x₁(t) and x₂(t) are transformed in the frequency-domain (step 210) using DCT and thereafter processed using Bark filtering (step 220) as already explained hereinabove with respect to the single channel speech enhancement method. Expressions (2) and (3) above are therefore equally applicable to each of the DCT components X₁(k) and X₂(k). Prewhitening (step 230) and subspace selection (step 240) based on the MDL criterion (expression (4)) is applied as before.

Similarly, reconstruction of the enhanced signal is obtained by applying the inverse DCT to components of the signal subspace and weighted components of the signal-plus-noise subspace as defined by expressions (5), (6) and (7) above.

The non-filtered weighting function in expression (7) is however modified and uses a coherence function Cⱼ (step 278) as well as the local SNRⱼ (step 275) of each Bark component as follows:

\tilde{g}ⱼ=exp {−vⱼ/(CⱼSNRⱼ)} j=p₁+1, . . . ,p₂ (16)

where the coherence function Cⱼ is evaluated in the Bark domain by:

$${C}_{j} = \frac{{P}_{x1x2} ( j )}{\sqrt{{P}_{x1x1} ( j ) + {P}_{x2x2} ( j )}} \qquad ( 17 )$$

where

Pₓ_{ₚ}ₓ_{_{q}}(j)=(1−λ_{κ})Pₓ_{ₚ}ₓ_{_{q}}(j)+λ_{κ}Xₚ(j)_{Bark}X_{q}(j)_{Bark} (18)

with p,q=1,2. The parameter v in expression (16) is adjusted through a non-linear probabilistic operator in function of the global signal-to-noise ratio SNR as already defined by expressions (9), (10) and (11) above.

Highest perceptual performance may as before be obtained by additionally tolerating background noise of a given level and use a noise compensation (step 290) defined in expressions (12) and (13) above.

Eventually, a final step may consist in an optimal merging of the two enhanced signals. A weighted-delay-and-sum procedure as described in S. Haykin, “Adaptive Filter Theory”, Prentice Hall (1991), may for instance be applied which yields finally the enhanced signal:

\tilde{s}(t)=w₁ŝ(t)+w₂ŝ₂(t) (19)

where w₁ and w₂ are chosen to optimize the posterior SNR.

With respect to the performance of the dual channel speech enhancement method of the present invention, it has been observed by the authors that the proposed dual channel subspace approach outperforms classical single channel algorithms such the single channel approach based on non-causal Wiener Filtering which is described in J. R. Deller et al., “Discrete-Time Processing of Speech Signals”, Macmillan Publishing Company, New York (1993). Tests have pointed out that the inclusion of the coherence function improves the perceptual performance of the single channel subspace approach which has been presented above.

Having described the invention with regard to certain specific embodiments, it is to be understood that these embodiments are not meant as limitations of the invention. Indeed, various modifications and/or adaptations may become apparent to those skilled in the art without departing from the scope of the annexed claims. For instance, the proposed optimization scheme which uses genetic algorithms shall not be considered as restricting the scope of the present invention. Indeed, it will be appreciated that any other appropriate optimization scheme may be applied in order to optimise the parameters of the proposed speech enhancement method.

Furthermore DCT has been applied to obtain components of the dual domain with in order to have maximum energy compaction, but Discrete Fourier Transform DFT is equally applicable despite being less optimal than DCT.

What is claimed is:

1. A method for enhancing speech in a noisy environment comprising the steps of:
a) sampling a input signal comprising additive noise to produce a series of time-domain sampled components;
b) subdividing said time-domain components in a plurality of overlapping frames each comprising a number N of samples;
c) for each of said frames, applying a transform to said N time-domain components to produce a series of N frequency-domain components X(k);
d) applying Bark filtering to said frequency-domain components X(k) to produce Bark components X(k)_{Bark}, said Bark components being given by the following expression:
$${( X ( k ) )}_{Bark} = {\sum }_{j = - b / 2}^{b / 2} G ( j , k ) {\{ X ( k - j ) \}}^{2} k = 0 , … , N - 1$$
where b+1 is the processing-width of the filter and G(j, k) is the Bark filter whose bandwidth depends on k, said Bark components forming a N-dimensional space of noisy data;
e) partitioning said N-dimensional space of noisy data into three different subspaces, namely:
a first subspace or noise subspace of dimension N−p₂ containing essentially noise contributions with signal-to-noise ratios SNRⱼ<1;
a second subspace or signal subspace of dimension p₁ containing components with signal-to-noise ratios SNRⱼ>>1; and
a third subspace or signal-plus-noise subspace of dimension p₂−p₁ containing components with SNRⱼ≈1; and
f) reconstructing an enhanced signal by applying the inverse transform to the components of said signal subspace and weighted components of said signal-plus-noise subspace.

2. The method according to claim 1, wherein steps a) to f) are performed based on a first and a second input signal respectively provided by first and second channels, said reconstructing step f) being performed using a coherence function Cⱼ based on Bark components X₁(k)_{Bark}, X₂(k)_{Bark} of said first and second input signal.

3. The method according to claim 1, wherein said partitioning step comprises using a Minimum Description Length, or MDL, criterion to determine the dimensions p₁, p₂ of said subspaces, said MDL criterion being given by the following expression:
$$MDL ( {p}_{i} ) = - ln \{ \frac{{\prod }_{j = {p}_{i} + 1}^{N} {λ}_{j}^{\frac{1}{N - {p}_{i}}}}{\frac{1}{N - {p}_{i}} {\sum }_{j = {p}_{i} + 1}^{N} {λ}_{j}} \} + M ( \frac{1}{2} + ln [ γ ] ) - \frac{M}{{P}_{i}} {\sum }_{j = 1}^{{P}_{i}} ln [ {λ}_{j} \sqrt{2 / N} ]$$
where i=1,2,M=pᵢN−pᵢ²/2+pᵢ/2+1 is the number of free parameters, λⱼ for j=0, . . . , N−1 are the Bark components rearranged in decreasing order, and γ is a parameter determining the selectivity of said MDL criterion.

4. The method according to claim 3, wherein said dimensions p₁ and p₂ are given by the minimum of said MDL criterion with γ=64 and γ=1 respectively.

5. The method according to claim 2, wherein said partitioning step comprises using a Minimum Description Length, or MDL, criterion to determine the dimensions p₁, p₂ of said subspaces, said MDL criterion being given by the following expression:
$$MDL ( {p}_{i} ) = - ln \{ \frac{{\prod }_{j = {p}_{i} + 1}^{N} {λ}_{j}^{\frac{1}{N - {p}_{i}}}}{\frac{1}{N - {p}_{i}} {\sum }_{j = {p}_{i} + 1}^{N} {λ}_{j}} \} + M ( \frac{1}{2} + ln [ γ ] ) - \frac{M}{{P}_{i}} {\sum }_{j = 1}^{{P}_{i}} ln [ {λ}_{j} \sqrt{2 / N} ]$$
where i=1,2,M=pᵢN−pᵢ²/2+pᵢ/2+1 is the number of free parameters, λⱼ for j=0, . . . ,N−1 are the Bark components rearranged in decreasing order, and γ is a parameter determining the selectivity of said MDL criterion.

6. The method according to claim 5, wherein said dimensions p₁ and p₂ are given by the minimum of said MDL criterion with γ=64 and γ=1 respectively.

7. The method according to claim 1, wherein said transform is a Discrete Cosine Transform (DCT).

8. The method according to claim 7, wherein said reconstructing step f) comprises applying the Inverse Discrete Cosine Transform to components of said signal subspace and weighted components of said signal-plus-noise subspace, said enhanced signal being given by the following expression:
$$\hat{s} ( t ) = {\sum }_{j = 1}^{p1} {a}_{{I}_{j}} ( t ) {X}_{{I}_{j}} + {\sum }_{j = p1 + 1}^{p2} {g}_{j} {a}_{{I}_{j}} ( t ) {X}_{{I}_{j}}$$
$$with$$
$${a}_{k} ( t ) = a ( k ) cos \{ \frac{π ( 2 t + 1 ) k}{2 N} \}$$
where λⱼ for j=1, . . . , N are the Bark components rearranged in decreasing order, Iⱼ is the index of rearrangement and gⱼ is an appropriate weighting function.

9. The method according to claim 8, wherein said weighting function gⱼ is given by the following expression:
$${g}_{j} ( k ) = {κ}_{a} {g}_{j} ( k - 1 ) {\sum }_{i = 0}^{{κ}_{ lagb}} {κ}_{bi} {\tilde{g}}_{j} ( k - i )$$
with
\tilde{g}=exp{−vⱼ/SNRⱼ} j=p₁+1, . . . , p₂
where SNRⱼ for j=0, . . . , N−1 is the estimated signal-to-noise ratio of each Bark component and parameter v is adjusted through a non-linear probabilistic operator in function of the global signal-to-noise ratio SNR, the parameters κₐ, κ_{lagb} and κ_{b1} to κ_{blagb}, being selected to optimize the speech enhancement method.

10. The method according to claim 8, steps a) to f) being performed based on a first and a second input signal respectively provided by first and second channels, said reconstructing step f) being performed using a coherence function Cⱼ based on Bark components X₁(k)_{Bark}, X₂(k)_{Bark} of said first and second input signal, wherein said weighting function gⱼ is given by the following expression:
$${g}_{j} ( k ) = {κ}_{a} {g}_{j} ( k - 1 ) {\sum }_{i = 0}^{{κ}_{ lagb}} {κ}_{bi} {\tilde{g}}_{j} ( k - i )$$
with
\tilde{g}ⱼ=exp{−vⱼ/(CⱼSNRⱼ)} j=p₁+1, . . . , p₂
where said coherence function Cⱼ is evaluated in the Bark domain by:
$${C}_{j} = \frac{{P}_{{x}_{1} {x}_{2}} ( j )}{\sqrt{{P}_{{x}_{1} {x}_{1}} ( j ) + {P}_{{x}_{2} {x}_{2} ( j )}}}$$
where
Pₓ_{ₚ}_{X}_{_{q}}(j)=(1−λ_{κ})Pₓ_{ₚ}ₓ_{_{q}}(j)+λ_{K}Xₚ(j)_{Bark}X_{q}(j)_{Bark p,q=}1,2
and where SNRⱼ for j=0, . . . , N−1 is the estimated signal-to-noise ratio of each Bark component and parameter v is adjusted through a non-linear probabilistic operator in function of the global signal-to-noise ratio SNR, the parameters κₐ, κ_{lagb} and κ_{b1} to κ_{blagb}, being selected to optimize the speech enhancement method.

11. The method according to claim 9, wherein said parameter v is adjusted as follows:
$${v}_{j} = \{ \begin{matrix}{f}_{1} \text{(} S \tilde{N} R \text{)} & if j \leq {p}_{1} \\ {f}_{2} \text{(} S \tilde{N} R \text{)} & if j \leq {p}_{2} \\ {f}_{3} \text{(} S \tilde{N} R \text{)} & if {p}_{2} < j \leq N\end{matrix}$$
where
ƒᵢ=κᵢ₁+κᵢ₂logsig{κᵢ₃+κᵢ₄SÑR}
and
SÑR=median(SNR(k), . . . , SNR(k−lagₖ))
where SNR(k) is the estimated global logarithmic signal-to-noise ratio and the parameters κ₁₁, κ₁₂, . . . , κ₄₄ are selected to optimize the speech enhancement method.

12. The method according to claim 11, wherein the parameters κₐ, κ_{lagb}, κ_{b1} to κ_{blagb}, and κ₁₁, κ₁₂, . . . , κ₄₄ are optimized by means of a so-called genetic algorithm.

13. The method according to claim 10, wherein said parameter v is adjusted as follows:
$${v}_{j} = \{ \begin{matrix}{f}_{1} \text{(} S \tilde{N} R \text{)} & if j \leq {p}_{1} \\ {f}_{2} \text{(} S \tilde{N} R \text{)} & if j \leq {p}_{2} \\ {f}_{3} \text{(} S \tilde{N} R \text{)} & if {p}_{2} < j \leq N\end{matrix}$$
where
ƒᵢ=κᵢ₁+κᵢ₂logsig{κᵢ₃+κᵢ₄SÑR}
and
SÑR=median(SNR(k), . . . , SNR(k−lag_{κ}))
where SNR(k) is the estimated global logarithmic signal-to-noise ratio and the parameters κ₁₁, κ₁₂, . . . , κ₄₄ are selected to optimize the speech enhancement method.

14. The method according to claim 13, wherein the parameters κₐ, κ_{lagb}, κ_{b1} to κ_{blagb}, and κ₁₂, . . . , κ₄₄ are optimized by means of a so-called genetic algorithm.

15. The method according to claim 11, further comprising a noise compensation step of the form:
\tilde{s}(t)=v₄ŝ(t)+(1−v₄)x(t)
where
v₄=f₄(SÑR)
and ƒ₄ is given by the expression defined in claim 11.

16. The method according to claim 13, further comprising a noise compensation step of the form:
\tilde{s}(t)=v₄ŝ(t)+(1−v₄)x(t)
where
v₄=f₄(SÑR)
and ƒ₄ is given by the expression defined in claim 13.

17. The method according to claim 10, further comprising a merging of a first enhanced signal reconstructed from components derived from said first channel and of a second enhanced signal reconstructed from components derived from said second channel.

18. A system for enhancing speech in a noisy environment comprising
means for detecting an input signal comprising a speech signal and additive noise;
means for sampling and converting said input signal into a series of time-domain sampled components; and
digital signal processing means for processing said series of time-domain sampled components and producing an enhanced signal substantially representative of the speech signal contained in said input signal,
wherein said digital processing means comprise:
means for subdividing said time-domain sampled components in a plurality of overlapping frames each comprising a number N of samples;
means for applying, for each of said frames, a transform to said N time-domain components to produce a series of N frequency-domain components X(k);
means for applying Bark filtering to said frequency-domain components X(k) to produce Bark components X(k)_{Bark}, said Bark components being given by the following expression:
$${X ( k )}_{Bark} = {\sum }_{j = - b / 2}^{b / 2} G ( j , k ) {\{ X ( k - j ) \}}^{2} k = 0 , … , N - 1$$
where b+1 is the processing-width of the filter and G(j, k) is the Bark filter whose bandwidth depends on k, said Bark components forming a N-dimensional space of noisy data;
means for partitioning said N-dimensional space of noisy data into three different subspaces, namely:
a first subspace or noise subspace of dimension N−p₂ containing essentially noise contributions with signal-to-noise ratios SNRⱼ<1;
a second subspace or signal subspace of dimension p₁ containing components with signal-to-noise ratios SNRⱼ>>1; and
a third subspace or signal-plus-noise subspace of dimension p₂−p₁ containing components with SNRⱼ≈1; and
means for reconstructing an enhanced signal by applying the inverse transform to the components of said signal subspace and weighted components of said signal-plus-noise subspace.
